(19) United States
(12) Patent Application Publication
(10) Pub. No.: US 2016/0279507 A1
(43) Pub. Date: Sep. 29, 2016

(54) ACTIVE LEARNING PUZZLE

(71) Applicant: PLAN-IT-CUBE LIMITED, Lasswade (GB)

(72) Inventor: Stephen O'BRIEN, Lasswade (GB)

(21) Appl. No.: 15/034,435

(22) PCT Filed: Nov. 4, 2013
(86) PCT No.: PCT/GB2013/052881

§ 371 Date: May 4, 2016

(51) Int. Cl. A63F 9/12; G09B 21/00; A63H 33/04; G09B 19/02

(52) U.S. Cl. CPC A63F 9/1204; G09B 19/02; G09B 21/003; A63H 33/04

(57) ABSTRACT

A puzzle comprising at least four blocks, each block having at least four sides, the at least four sides of each block having at least two different colors, for example red, blue and yellow, at least one side of each block each having at least one feature thereon, for example a shape, a flag/emblem and a mode of transport, such as a car, a boat and a helicopter.

### CROSS-REFERENCE TO RELATED APPLICATIONS

This application is a national stage application (filed under 35 § U.S.C. 371) of PCT/GB2013/052881, filed Nov. 4, 2013; the contents of which is hereby incorporated by reference.

### FIELD OF THE INVENTION

The present invention relates to a puzzle that encourages active playing and learning. In addition, the invention relates to a method of playing a game using the puzzle.

### BACKGROUND OF THE INVENTION

In recent years, there has been a drive to improve physical activity levels in school through what is termed active learning. Indeed in the UK, alone there is a plethora of national strategies and guidelines on active playing and learning. However, at a time when many children are less active in mind and body, there are few real physical examples of active playing and learning in a school environment.

### SUMMARY OF THE INVENTION

According to one aspect of the invention, there is provided a puzzle comprising at least four blocks, each block having at least four sides, the sides of each block having at least two different colors, at least one side of each block each having at least one feature thereon. By feature, it is meant any visual marker is sign that overlays the colored face it is on, for example a graphical image, a letter or a number.

Associated with the blocks is a plurality of flash cards that define patterns that have to be recreated using the blocks. The flash cards can be provided as hard copies or generated electronically, for example using a personal computing device, such as a desktop PC or a tablet or smart phone or some other a portable computing device. Where the flash cards are generated electronically, they may be stored and then later presented to a user. Alternatively, the flash cards may be generated at the time of use based on knowledge of the configuration of the blocks and according to one or more predetermined criteria, such as degree of difficulty.

By mixing color and features, such as graphical images, letter or numbers, on at least two sides of each block, matching the blocks is relatively complex. This is because different parts of the brain process color and graphical images/letter/numbers, and having a mix of these on two or more faces of each block makes matching the blocks relatively complex. This complexity can be increased by having two or more features on at least one side of a block. For example, where the main feature is a shape, a smaller shape could be inlaid within the main shape. The inlaid feature could be the same shape as the main shape or a different shape from the main shape. For example, the main shape could be a square and the inlaid shape could be a smaller square or a circle or a triangle or a diamond or any other shape. The inlaid shape may be the same color as the face on which the main shape is located. For further complexity, the inlaid shape could be a different color from the color of the side on which the main shape is located.

Multiple different types of feature may be provided, such as a graphic, or type of graphical image, a letter and/or a number. The types of graphical image may include symbols, emblems/flags, geometric shapes, images of objects such as vehicles, and animals. All blocks in the puzzle may have the same grouping of features, i.e. every block may have one instance of each type of feature. For example, if the features are emblems/flags, geometric shapes, images of vehicles, numbers and letters, then every block has to have one instance of each type of feature, in this case an emblem/flag, a shape, a vehicle, a letter and a number.

At least one type of feature, and optionally all types of feature, may appear multiple times on the same color within the overall set of blocks. In this case, different features within a specific type may appear on the same color. For example, where the type of feature is type of graphical image, such as a geometric shape, then different shapes may appear on the same color. Where the type of feature is an image a vehicle, then different vehicles may appear on the same color. Where the type of feature is an emblem/flag, then different emblems/flags may appear on the same color. Every feature may appear on every color.

For every type of feature, the number of features may be a multiple of the number of different colors. For example, where there are N colors, N different shapes and/or N different vehicles and/or N different emblems/flags may be used.

The features may be selected from: a graphic, a letter and a number. The graphic may represent a shape and/or an object and/or a symbol. The shape may be a geometric shape, for example a circle, a square, a triangle, a diamond or a kite or other shape. The object may be a vehicle for example a car, a helicopter and a boat. The symbol may be a flag and/or a national emblem.

At least two sides of at least one block may have different features thereon. Preferably, at least one side of each block has at least one graphic, at least one other side of each block has a letter and at least another side of each block has a number. Hence, each block has a graphic, a number and a letter.

Every block may have a different number. Every block may have a number that is part of a sequence or pattern of numbers. The sequence of numbers on the blocks may correspond to the total number of blocks. For example, where there are four blocks, the numbers may be 1, 2, 3 and 4, with each block having a different number. Where there are nine blocks, the numbers may be 1, 2, 3, 4, 5, 6, 7, 8 and 9 again with each block having a different number. Other number sequences may be possible, such as sequences of even numbers or sequences of odd numbers or sequences of prime numbers.

Every block may have a letter. Every block may have a different letter. Every block may have a letter that is part of a sequence or pattern of letters. For example, where there are four blocks, the letters may be A, B, C and D, with each block having a different letter. Where there are nine blocks, the letters may be A, B, C, D, E, F, G, H and I again with each block having a different letter. Other letter sequences may be possible, such as sequences of vowels.

Every block may have a letter and a number. The letters and numbers may be mapped to each other. The letters and numbers may be mapped to each other according to a sequence. For example, one block may have the number 1 and the letter A, second block may have a number 2 and the letter B, a third block may have a number 3 and the letter C etc. For a given block, the number and the letter may be on sides that are of the same color. Alternatively, the number and the letter may be on different colored sides.

The colors may be primary colors. The colors may be red, yellow and blue. However, other colors could be used. Equally different shades of the same color could be used. In the context of the present application, different color is to be interpreted as including different shade of the same color.

Each block may have six sides. Each block may be a cube or a cuboid.

The blocks may be provided in groups of M by N, where M and N are integers. For example, the blocks may be provided in groups of two by two, or three by three, or four by four, or five by five, or six by six. Preferably, M=N and so the number of blocks is an integer squared, for example 4, 9, 16, 25, etc.

Where the number of blocks is an integer squared (N²), the number of different colors may correspond to the integer N. For example, for a four block puzzle the number of different colors may be two; for a nine block puzzle the number of different colors may be three (for example red, blue, yellow); for a sixteen block puzzle the number of different colors may be four (for example red, blue, yellow, green).

Where there are nine blocks, each block may have a number in the sequence 1, 2, 3, 4, 5, 6, 7, 8 and 9. This is useful for younger children as it helps them familiarise themselves with basic numbers. Equally, where there are nine blocks, each block may have a letter in the sequence A, B, C, D, E, F, G, H and I, so younger children can familiarise themselves with the first nine letters of the alphabet.

The blocks may be stackable and/or the blocks may fit together to form a pre-determined shape.

The blocks may be physical blocks that users physically pick up and place into the pattern of the flashcard. In this case, each block may have at least one dimension greater than 20 cm, preferably 30 cm or more. Alternatively, each block could be pocket or travel sized, for example having dimensions in the range from 1 cm to 5 cm, or for slightly larger blocks 5 cm to 10 cm.

Alternatively, the blocks may be generated using computer graphics. In this case, the puzzle may be a computer program product preferably on a data carrier or a computer readable medium. The computer program product comprises code and/or instructions for implementing the puzzle, so that a user can play the puzzle on a computing device that has a display or screen.

According to another aspect of the invention, there is provided a puzzle comprising multiple double sided playing cards, each side of each card having a color selected from at least two different colors, and at least one side of each card having at least one feature thereon. Preferably, three colors are used, for example red, blue, and yellow. Ideally, every card is different distinguished by its own color/feature combination. Both sides of a given card may be the same color.

At least one side of each card may have at least two features thereon. One of the two features may inlaid or inside the other of the at least two features.

The features may be selected from: a graphic, a letter and a number. The graphic may represent a shape and/or an object and/or a symbol. The shape may be a geometric shape, such as a circle, a square, a triangle, a diamond and kite. The object may be a vehicle, for example a car, a helicopter and a boat. The symbol may be a flag and/or an emblem.

Each side of a given card may have a different feature thereon. One side of the card may have at least one graphic and the one other side of the same card has a letter or number thereon.

At least some of the cards may have numbers, thereon. The numbers may part of a sequence or pattern of numbers. At least some of the cards may have letters, thereon and the letters may be part of a sequence or pattern of letters.

The colors may be primary colors. The colors may be red, yellow and blue. The cards may fit together to form a pre-determined shape.

Twenty seven cards may be provided, so that there are fifty four faces.

Some faces may be color only faces. Some of the color only faces may be the same color, so that there is an element of replication of the color only. For example, where there are three colors, there may be three color only faces for each color, such as three red only faces, three blue only faces and three yellow only faces.

Each face that has a feature on it may be different from every other face that has a feature on it. The difference may be in the color of the face. For example, the same feature may be used multiple times, but on different colored faces.

The at least one feature may be represented in braille.

A plurality of flash cards may be provided each defining a different pattern that has to be recreated using the double sided cards, for example more than twenty cards, more specifically fifty cards. The flash cards may be provided as hard copies or generated electronically. The cards may be physical cards or generated electronically.

### BRIEF DESCRIPTION OF THE DRAWINGS

Various aspects of the invention will now be described by way of example only and with reference to the accompanying drawings, of which:

FIG. 1 is a schematic view of a nine block active learning and playing puzzle;

FIG. 2 is a plan view of every face of each block of the puzzle of FIG. 1;

FIG. 3 is an unfolded view of a single block of the puzzle of FIG. 1;

FIG. 4 is a view of all of the red faces of the blocks of FIG. 1;

FIG. 5 is a view of all of the yellow faces of the blocks of FIG. 1;

FIG. 6 is a view of all of the blue faces of the blocks of FIG. 1;

FIG. 7 is a first flashcard for use with the nine blocks of FIG. 1;

FIG. 8 is a second flashcard for use with the nine blocks of FIG. 1;

FIG. 9 is a third flashcard for use with the nine blocks of FIG. 1;

FIG. 10 is a fourth flashcard for use with the nine blocks of FIG. 1;

FIG. 11 is a fifth flashcard for use with the nine blocks of FIG. 1;

FIG. 12 is a plan view of every face of each block of a more complex version of the nine block puzzle of FIG. 1;

FIG. 13 a first flashcard for use with the nine blocks of FIG. 12, and

FIG. 14 a second flashcard for use with the nine blocks of FIG. 12.

### DETAILED DESCRIPTION OF THE DRAWINGS

The present invention provides a puzzle has multiple layers of complexity to test and challenge players. In a preferred embodiment, the puzzle uses four phase differential coding. This uses a numerical code; a letter code; a color code and a graphic code. These four features are used in combination to provide multiple visual images that have to be matched in order to play the game. In all cases, the color code is used alone or in combination with the other codes. The numerical code; the letter code, and the graphic code are always used in combination with the color code. This mixing of color and images (whether graphic or alpha numeric) presents the human brain with particular mental challenges.

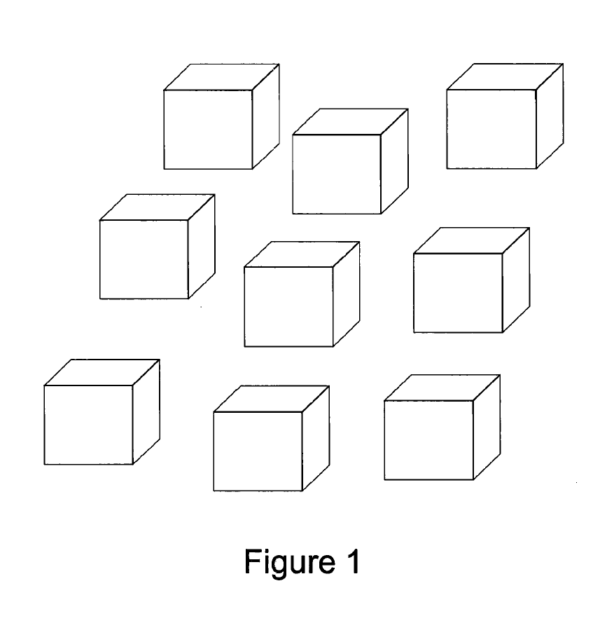

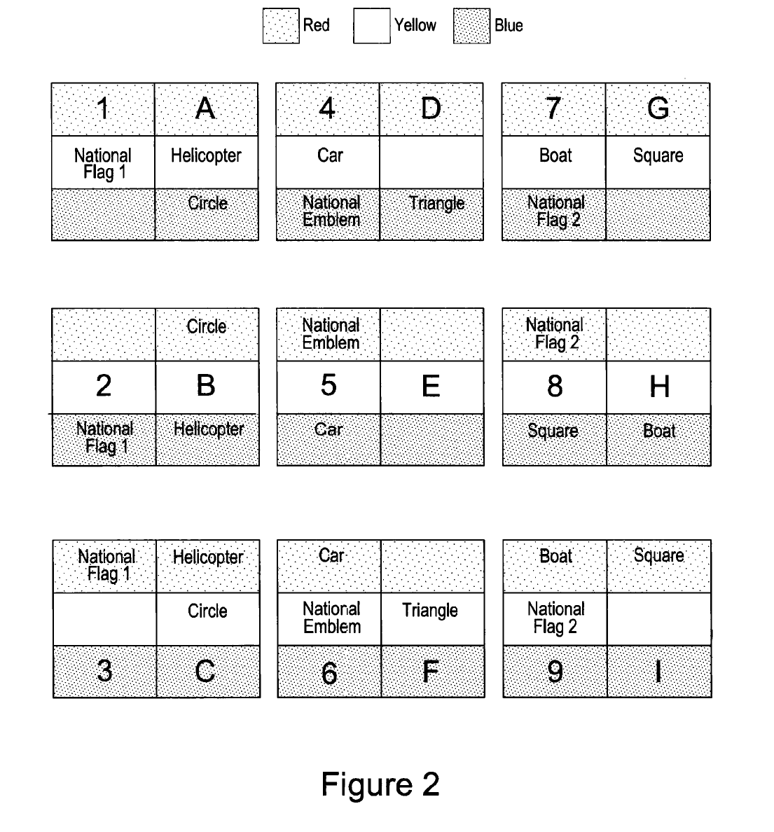

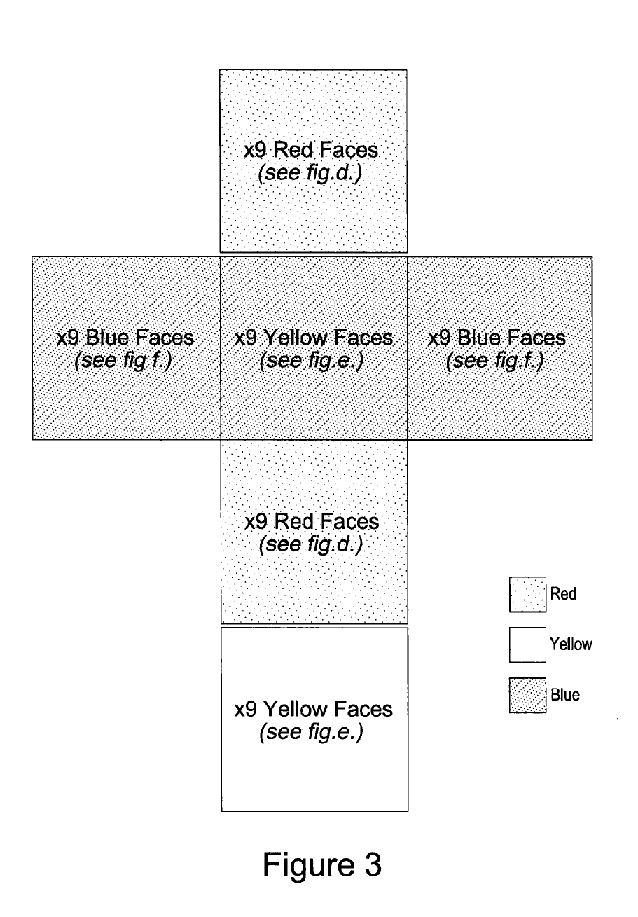

FIG. 1 shows an active learning and playing puzzle that has nine three dimensional blocks. In this case, each block is a cube having six faces, so that in the complete nine block set there are fifty four faces. Features (not shown) are provided on the faces of each block. These are described in more detail with reference to FIGS. 2 and 3. The blocks are provided with a plurality of flash cards that define three by three patterns that are made up of nine faces of the blocks. In its most basic form, the game involves reconstructing the pattern on one of the cards using the blocks.

To maximize active learning and playing, each block is relatively large, for example around thirty centimetres cubed. Each block is stackable so that a wall can be built. Alternatively, the blocks can be laid on a flat surface. Moving the blocks into place and building the wall or arranging them on the flat surface requires physical movement and effort. Matching the block faces to the selected pattern requires concentration and focus. Hence, the puzzle achieves active learning and playing in a simple and fun way that can appeal to children of all ages.

FIG. 2 shows the six faces of each block of the nine block puzzle. Each cube face is colored. Three colors are used. One pair of faces has the first color; one pair has the second color, and the third pair has the third color. The colors used in this example are red, yellow and blue. Other colors could be used, but this primary trichromatic scheme is typical of how humans process color

Every block has a face that has a number. Every block has a face that has a letter. Every block has a face that has a flag or national emblem. Every block has a face that has a vehicle. Every block has a face that has a shape. Every block has a face that has a color alone, with no other number, letter, graphic or symbol. This means there are nine faces with numbers, nine faces with letters, nine faces with flags/national emblems, nine faces with vehicles, nine faces with shapes and nine faces with color-only.

From FIG. 2, it can be seen that every block has a different number, these ranging from 1 to 9. Every block has a different letter, these ranging from A to I. In this example, 1 is mapped to A and appears on the same block; 2 is mapped to B; 3 is mapped to C; 4 is mapped to D; 5 is mapped to E; 6 is mapped to F; 7 is mapped to G; 8 is mapped to H, and 9 is mapped to I. However, any other mapping could be used. Each number and letter pair on a given block is in the same color. Three basic shapes are used, these being a circle, a triangle and a square. Each shape appears on three different blocks and in three different colors. Three basic vehicles are used, these being a helicopter, a car and a boat. Other vehicles could be used. Each vehicle appears on three different blocks and in three different colors. Three basic flags/emblems are used, these being national flag 1, national flag 2 and national emblem. Each flag/emblem appears on three different blocks and in three different colors.

For the three blocks that have numbers 1 to 3, and corresponding letters A to C, the other faces have national flag 1, the helicopter, circle and a single color. Comparing these three blocks, each number, letter, national flag 1, helicopter, and circle is on a different colored face. For the block with 1 and A, the helicopter is on the yellow face, for the block with 2 and B, the helicopter is on the blue face, and for the block with 3 and C, the helicopter is on the red face. Likewise, for the block with 1 and A, the circle is on the blue face, for the block with 2 and B, the circle is on the red face, and for the block with 3 and C, the circle is on the yellow face. For the block with 1 and A, the national flag 1 is on the yellow face, for the block with 2 and B, the national flag 1 is on the blue face, and for the block with 3 and C, the national flag 1 is on the red face. For the block with 1 and A, the color only face is blue, for the block with 2 and B, the color only face is red, and for the block with 3 and C, the color only face is yellow.

For the three blocks that have numbers 4 to 6, and corresponding letters D to F, the other faces have national emblem, a car, a triangle and a single color. In this case, for the block with 4 and D, the car is on the yellow face, for the block with 5 and E, the car is on the blue face, and for the block with 6 and F, the car is on the red face. Likewise, for the block with 4 and D, the triangle is on the blue face, for the block with 5 and E, the triangle is on the red face, and for the block with 6 and F, the triangle is on the yellow face. For the block with 4 and D, the national emblem is on the blue face, for the block with 5 and E, the national emblem is on the red face, and for the block with 6 and F, the national emblem is on the yellow face. For the block with 4 and D, the color only face is yellow, for the block with 5 and E, the color only face is blue, and for the block with 6 and F, the color only face is red.

For the three blocks that have numbers 7 to 9, and corresponding letters G to I, the other faces have national flag 2, a boat, a square and a single color. In this case, for the block with 7 and G, the boat is on the yellow face, for the block with 8 and H, the boat is on the blue face, and for the block with 9 and I, the boat is on the red face. Likewise, for the block with 7 and G, the square is on the yellow face, for the block with 8 and H, the square is on the blue face, and for the block with 9 and I, the square is on the red face. Finally, for the block with 7 and G, the national flag 2 is on the blue face, for the block with 8 and H, the national flag 2 is on the red face, and for the block with 9 and I, the national flag 2 is on the yellow face. For the block with 7 and G, the color only face is blue, for the block with 8 and H, the color only face is red, and for the block with 9 and I, the color only face is yellow.

FIG. 3 shows an example of the arrangement of the color faces for a single block, with the block shown unfolded. In this case, each six sided block has three opposing colored sides namely, red, yellow and blue. Other colors could be used. Equally, the colors do not have to oppose each other. Based on this configuration, there are eighteen red faces, eighteen blue faces and eighteen yellow faces.

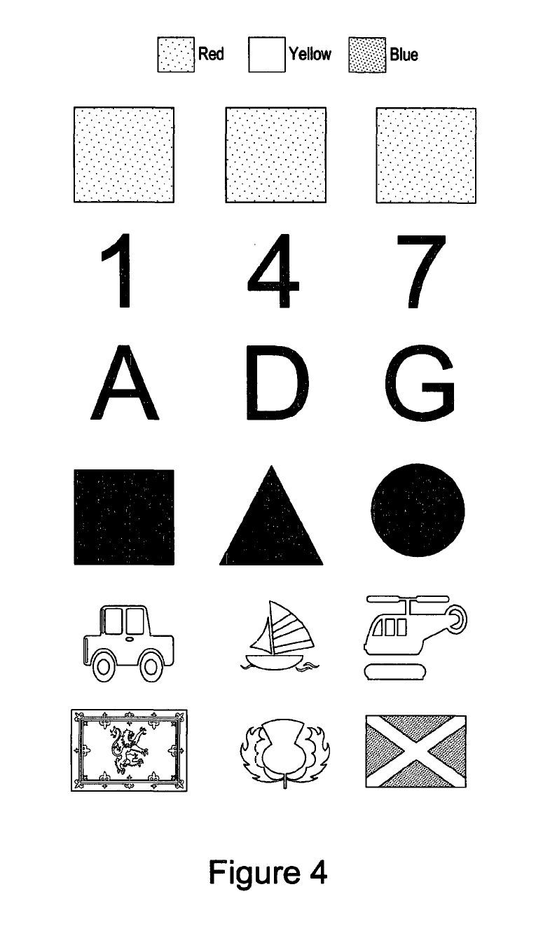

FIG. 4 shows the numbers, letters, shapes, vehicles and flags/national emblems that are applied to the red faces of the nine block set, i.e. to the eighteen red faces. In this case, the number of features is a multiple of the total number of colors (in this case three—red, blue, and yellow). For example, there are three numbers, three letters, three shapes, three vehicles and three flags/emblems, as well as three red only faces. The numbers on the red faces are 1, 4 and 7, and the letters are A, D and G. Each of the three shapes, i.e. a square, triangle and a circle, appears once on a red face. Each of the three vehicles, i.e. a car, boat and a helicopter, appears once on a red face. Each of the three flags/emblems, i.e. national flag 1, national emblem and national flag 2, appears once on a red face. There are also three red faces with no number, letter or image.

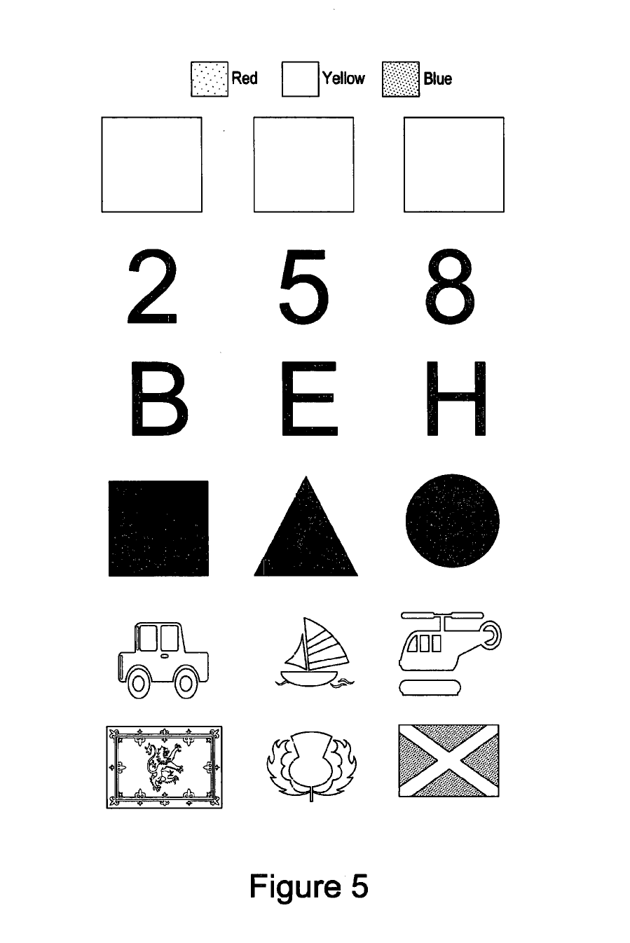

FIG. 5 shows the numbers, letters, shapes, vehicles and flags/national emblems that are applied to the eighteen yellow faces of the nine blocks. Again, the number of features is a multiple of the number of colors. For example, there are three numbers, three letters, three shapes, three vehicles and three flags/emblems, as well as three yellow only faces. The numbers on the yellow faces are 2, 5 and 8, and the letters are B, E and H. Each of the three shapes, i.e. a square, triangle and a circle, appears once on a yellow face. Each of the three vehicles, i.e. a car, a boat and a helicopter, appears once on a yellow face. Each of the three flags/emblems, i.e. national flag 1, national emblem and national flag 2, appears once on a yellow face. There are also three yellow faces with no number, letter or image.

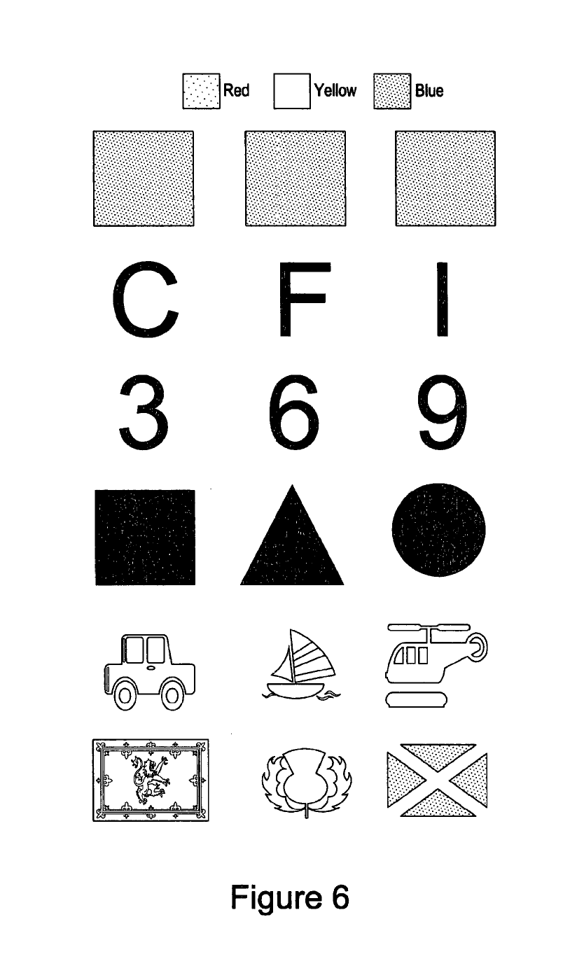

FIG. 6 shows the numbers, letters, shapes, vehicles and flags/national emblems that are applied to the eighteen blue faces of the nine blocks. As before, the number of features is a multiple of the number of colors, i.e. three numbers, three letters, three shapes, three vehicles and three flags/emblems, as well as three blue only faces. The numbers on the blue faces are 3, 6 and 9, and the letters are C, F and I. Each of the three shapes, i.e. a square, triangle and a circle, appears once on a blue face. Each of the three vehicles, i.e. a car, a boat and a helicopter, appears once on a blue face. Each of the three flags/emblems, i.e. national flag 1, national emblem and national flag 2, appears once on a blue face. There are also three blue faces with no number, letter or image.

Each puzzle is accompanied by flash cards that each depict one combination of the more than 10 million that exist in the case of the three by three set. The flash cards can be provided as hard copies or generated electronically. Where the flash cards are hard copies, typically a set of around 50 is provided. Where the flash cards are generated electronically, they may be stored and then later presented to a user. Alternatively, the flash cards may be generated at the time of use based on knowledge of the configuration of the blocks and according to one or more predetermined criteria, such as degree of difficulty.

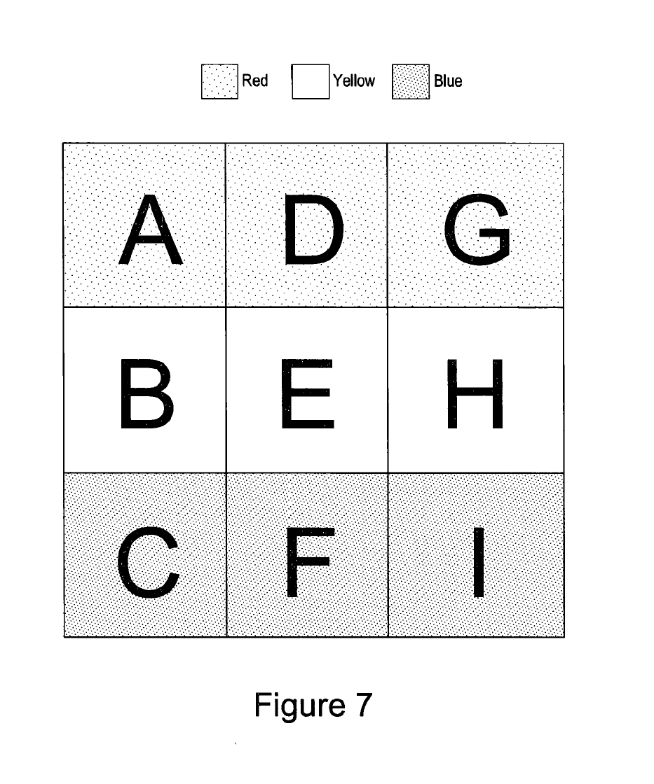

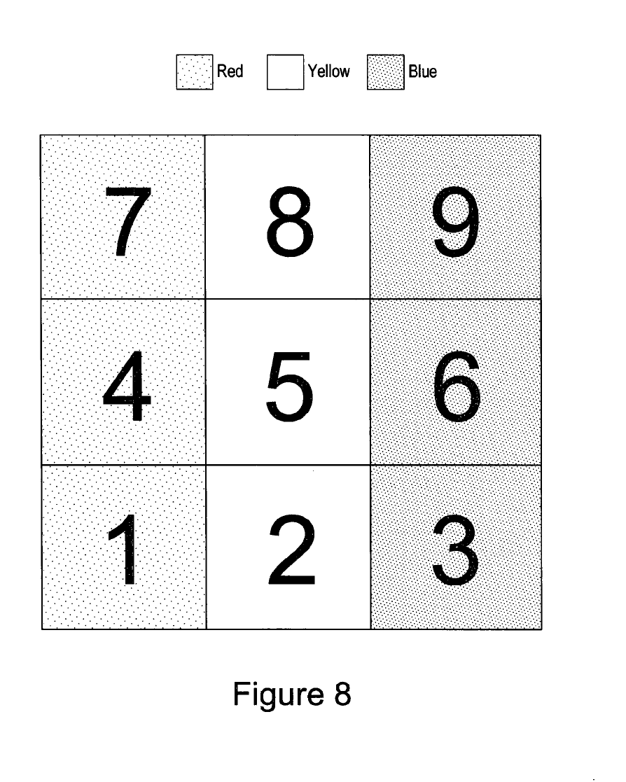

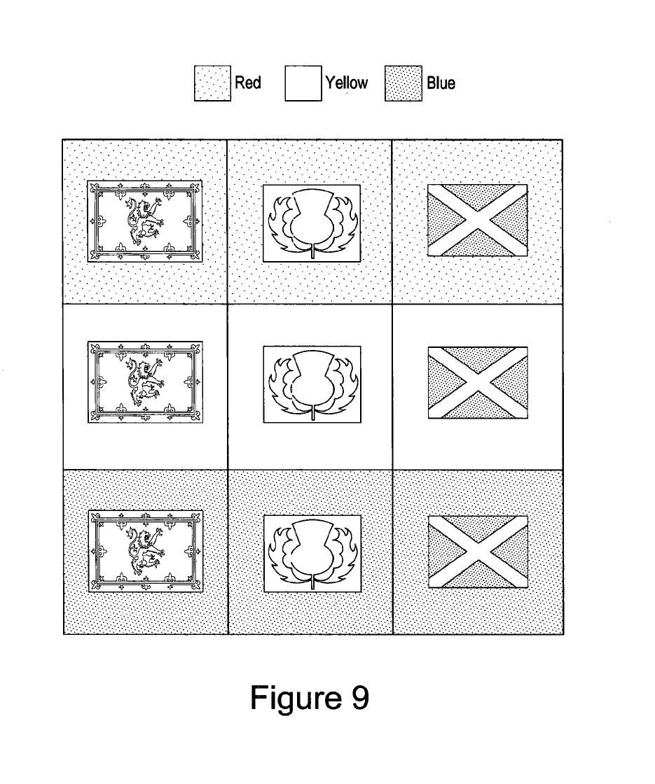

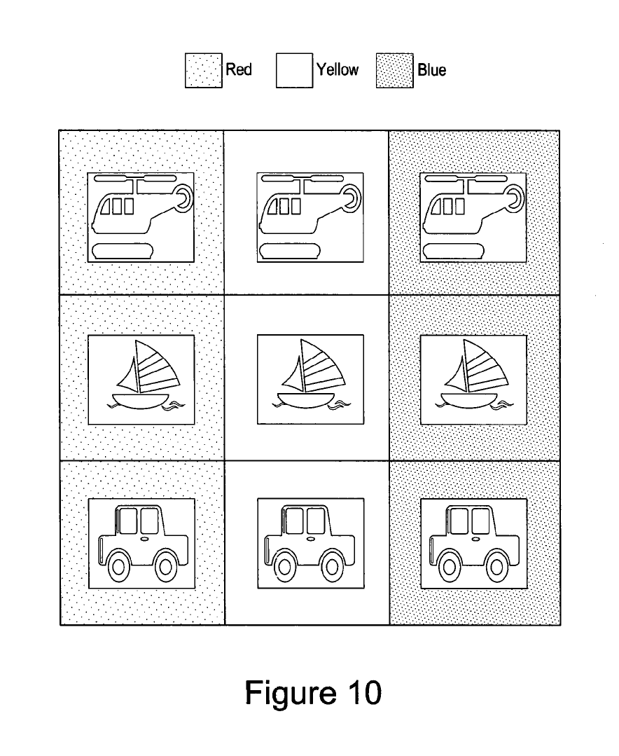

The pattern on the flash card sets the task for the player, who has to arrange the blocks to match the pattern. FIG. 7 shows a very simple letter based flash card that has red faces with A, D, G on the top row, yellow faces with B, E, H on the middle row and blue faces with C, F, I on the bottom row. In this case, like colors are in horizontal rows. FIG. 8 shows a very simple number based flash card that has red faces with 1, 4, 7 in the left hand column, yellow faces with 2, 5, 8 in the middle column, and blue faces in the right hand column with 3, 6, 7. In this case, like colors are in vertical columns. FIG. 9 shows a simple flag/emblem based flash card that has horizontal rows of like colored faces, each with one of the national flag 1, national emblem, and national flag 2. FIG. 10 shows a simple vehicle based flash card that has vertical columns of like colored faces, each with one of a car, a boat and a helicopter.

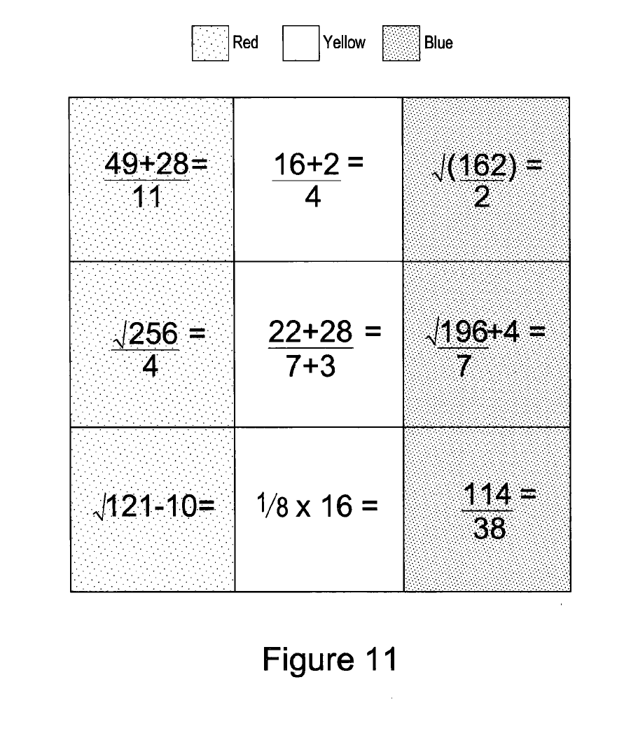

Many millions of possible flash card combinations are possible. Cards may vary in difficulty in terms of processing information within combinations. Flash cards can also be provided in various formats. For example, FIG. 11 shows a variation of the numerical flash card. Here, instead of showing simply numbers on the blocks, each face presents a calculation that has to be done to work out the relevant number. Although this representation depicts simple arithmetical functions, information in any subject area could be presented by way of a question, decipherable code, color, shape, pattern, symbol, alphanumeric or otherwise.

The puzzle has a mix of number, letters, shapes are colors selected to present information that the human brain interprets and processes in different ways. This mixing of information means that the puzzle can help train and build mental agility and improve players' ability to deal with different types of information. Humans are Trichromats and process color by way of three distinct types of retina receptor cells with each being sensitive to different light properties. Red is the most emotionally intense color; it attracts and divides attention differently in males and females. If prevalent, red can cause difficulty in negotiations and confrontation. These are two obstacles that players must overcome by building co-operation and teamwork. Red increases heartbeat and breathing. Yellow is the most difficult color for the eye to take in as it can be overpowering. Yellow enhances concentration and also speeds up metabolism. Blue is the easiest color on the eye, it causes the body to produce calming chemicals and induces focus. The brain processes color in two separate pathways and although the objects shape and color normally are linked, the neural representation of the color can survive alone. When that happens the brain establishes a new link that binds the color to a new visible shape. The human brain processes color and patterns, horizontally and vertically, suppressing conflicting information the eyes take in. The puzzle of the invention helps build and train the mind to deal with confusing information that is being processed concurrently in two separate parts of the brain.

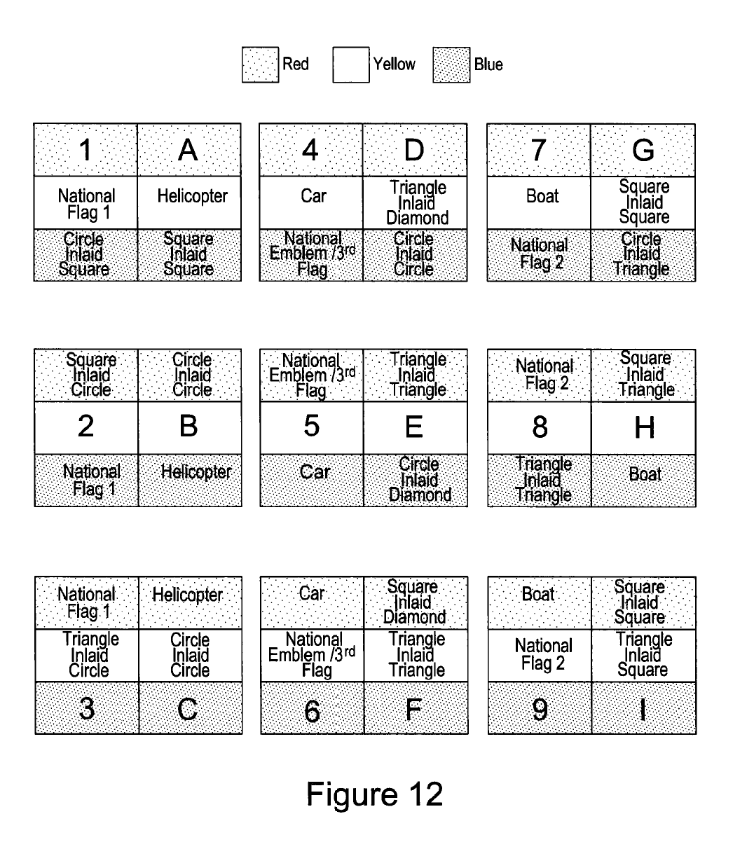

FIG. 12 shows a more complex version of the puzzle of FIG. 1. In this case, the color and simple shape faces are replaced by a color and a shape with an inlay. In addition, the color only faces are replaced by a color and another different shape with an inlay. This means that each block has two faces with an inlay, so there is a total of eighteen inlaid shape silhouette faces displayed on the nine blocks. No block carries two identical inlaid silhouette shapes.

Each of the eighteen faces carrying a shape is inlaid with one of four smaller shapes namely, triangles, circles, squares and diamonds, although other geometric inlaid shapes could be used. For the square, circle and triangle inlays, each inlaid shape repeats five times, three times in the larger version of the same shape and in each color, and once each in the other two larger shapes. The diamond inlay appears only three times inlaid in three different silhouette shapes and represented once in each of the three colors. It completes the final three faces of the total eighteen inlaid shaped silhouettes. Each of the smaller inlaid shape matches the color of the face it features on, adding a third layer of variability per face. Alternatively, for an even more complex puzzle, the inlaid shape may have a color that is different from the color of the face it is on. This results in a fourth level of complexity on the same face. All of this adds visual/mental and physical complexity of the task for hand and eye.

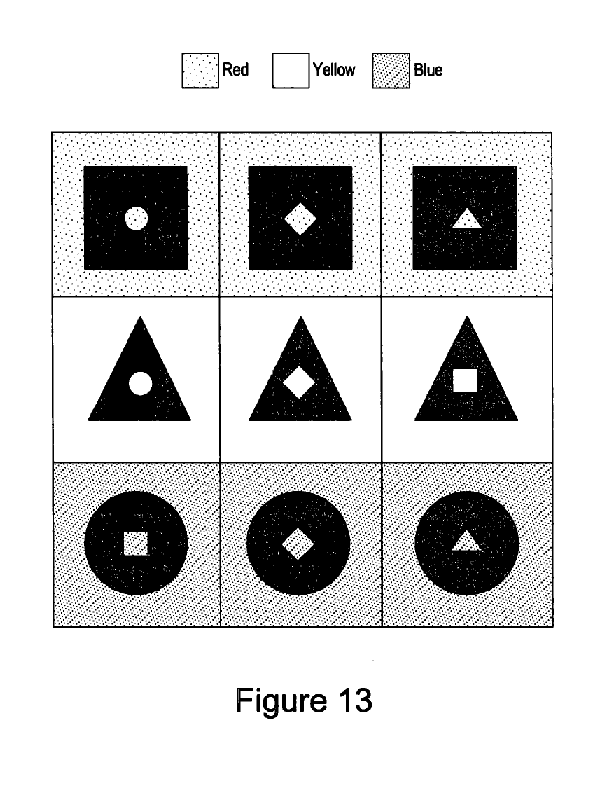

FIG. 13 shows an example of an inlaid shape based flash card that has red faces with large squares on the top row, the large squares having circle, diamond and triangle inlays, yellow faces with large triangles in the middle row, the large triangles having circle, diamond and square inlays, and blue faces with large circles in the bottom row, the large circles having square, diamond and triangle inlays on the bottom row. In this case, like colors and like large shapes are in horizontal rows.

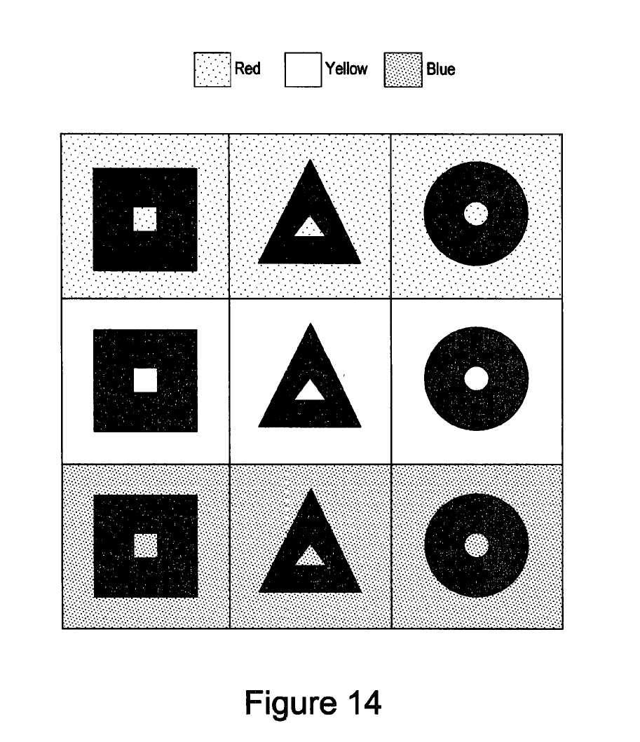

FIG. 14 shows another example of an inlaid shape based flash card that has red faces with a large square, a large triangle and a large circle on the top row; yellow faces with a large square, a large triangle and a large circle in the middle row, and blue faces with a large square, a large triangle and a large circle in the bottom row. In all cases, the large shapes have inlays of the same shape. In this case, like colors are in horizontal rows and like large shapes are in vertical columns.

Some of the faces of the puzzle of FIG. 12 have three layers that have to be taken into account for matching, these being the color, the large shape and in the inlay. These three layers add significantly to the complexity of the puzzle

The puzzle of the invention can be used to play numerous different games. For example, a simple beat the clock game could be played with individuals or teams. In this case, someone has to pick a flash card that sets out the pattern that has to be built. Players are timed to see how quickly they complete the challenge. Players indicate they have completed it, by sitting down. The puzzle is then checked for accuracy before player(s) are given a time. Then players can try to improve their time or pick a harder combination and beat the clock again. Beat the clock can be played individually or in teams of two or more players. Ideally, teams should not be told their time until all teams have had a round of play. Groups can be given a team name and times awarded.

Another game is a team race, in which two or more teams compete against each other to try to complete the puzzle fastest. This requires two or more sets of cubes. To increase the physical aspect of this game, the first part of the race may involve running along a path towards sets of cubes. Obstacles may be put in the path of the players, such as cones, hurdles, benches, so that they have to climb over/under/through the obstacles. When all players and cubes are at the end is a flash card turned over. Teams then build and copy what is on the card. Again, teams sit down to indicate their attempt is complete. At this point, the flash cards are removed. Teams are not told whether they have been successful just yet. Check combinations are right. Reveal runners up then winners.

For a team to win they must match the combination on the flash card, faster than the other team(s). If a team sits down and a mistake is made, the other team wins if they have correctly completed the puzzle; albeit in a slower time. If both teams have made one mistake the faster team wins. If more than one mistake has been made per team; then the team with the least mistakes wins. In the event of a draw, due to mistakes made being equal; the team with the best or neatest built wall wins. If it then remains a draw, the race is run again.

Yet another team game option is blind block. This starts with one player from each team being nominated. That player chooses or is given a flashcard and holds the card facing them. They must not show it to their team-mates. That player describes the combination they are holding to the rest of the team. The team builds what is being described to them. The clock stops once they have all sat down, to indicate they have completed the task and it is checked for accuracy. Blind block can be played with more than one person describing the combination and played in conjunction with team race and beat the clock.

Other more advanced games can be played. The advanced player mode starts with a player building from a flash card held upside down or quarter turned, left or right, individually or in teams. Greater advanced play involves players/teams being given a combination to build and given one minute to memorize the flash card. The individual/team then carries the blocks through the course to the finish line and reassembles the memorized combination. Members of teams can remember 1, 2 or 3 (as many as they can) each in order to improve as they play. Individuals need only rebuild it where they knock it over, under same advanced player mode.

As noted above, the blocks of the puzzle may be 300 mm cubed. They may be approximately 900 g per block. Whilst the blocks are described as being cubes, other geometric shapes may be used. The blocks may be made of any suitable material, such as wood, plastic, metal. The blocks may be suitable for indoor or outdoor use, for example the blocks may be waterproof. Alternatively, a handheld version of the puzzle could be implemented. This could help with improving mental agility, but would lack the physical aspect of the large sized embodiment. Equally, the puzzle could be computer implemented, for example in computer software. All of the basic principles of the puzzle described herein can be computer program implemented. Graphics programs for generating shapes and allowing rotation and placement of such shapes are well known in the art and so will not described.

The present invention provides a puzzle that can help players learn and develop physical and mental skills. This can be enhanced by using images on the blocks specifically selected to help with learning. For example, national flags and emblem insignia are used as national curricula in schools often emphasize the need to raise national identity awareness. With so many economic migrants throughout the world, prevalence of national insignia is being reinforced by education authorities and governments. Other images could be used to cover specific subjects, for example, animals, history, geography, music, science, languages, sports, physical education, travel and tourism.

Although the invention has been described in the context of a three by three grid of blocks, other arrangements could be used, for example N by N, such as 2×2, 4×4, 5×5, 6×6, etc., as well as rectangular configured multiplication i.e. M by N (M not equal to N) 3×2, 4×3, 5×3, 5×4, 6×5, 6×4, 7×6 . . . etc. In this case, ideally the number of different colors used is matched to one-dimension of the grid. For example, for a four by four grid, four different colors may be used, for example red, blue, yellow and green, and for a 3 by 2 grid three different colors may be used, for example red, blue and yellow. In addition, the number of features may be a multiple of the number of colors. For example, for the four by four puzzle, there could be sixteen numbers, sixteen letters, four shapes (one on each color, so sixteen in total), four vehicles (one on each color, so sixteen in total), four emblems/flags (one on each color, so sixteen in total) and four color only faces (for each color, so sixteen in total) or four other object feature faces (for example four animals, one on each color, so sixteen in total). Each set would have a unique combination attributable to it.

Other variations of the puzzle are possible. For example, uni, bi-, tri- or multiple colored schemes could be used with relevant symbol facia. Equally, at least one face could be segmented to allow one, two or multiple uses of shape or colored segments divided equally into halves, thirds, quarters etc. (e.g. on an individual face with matching flash card). Other versions could include alphanumerics in a variety of ways that may include numeral sequencing (e.g. 2, 4, 6, 3, 6, 9 etc.) or powers (1, 10, 100, 1000 etc.). Mathematical operators (+,−,/, ×, %) or mathematics/physics functions/values such as a(π, Σ, Δ, √, Ω, ∞, etc.) may be used. Other symbols, mathematical representations & numerals could be represented e.g. Roman numerals, binary, hexadecimal and all other numeral code/structure. Also, the puzzle may be implemented in braille language. In this case, the features on the faces of the blocks would be represented in braille, and a marker would be provided to indicate the face color. To do this, faces of the blocks may have indented or raised portions so that the features can be read by touching the block faces. Equally, the blocks could be provided with simple audio systems for generating sound in response to touch, where each sound could represent a given color or feature. The sound may be the spoken word, for example yellow to represent the color yellow, and car to indicate that the face has a car on it. This may be useful for blind players.

Whilst the puzzle has been described primarily in the context of three dimensional blocks, a two dimensional version may be possible. For the two dimensional version, the puzzle would be provided in the form of double sided playing cards, rather than using blocks. In this case, the cards would be double sided. As a simple example, to translate the three by three puzzle, described with reference to FIGS. 1 to 14, into a card game, opposing sides of each block would be represented by a single double sided card. Hence, for the nine block puzzle that has fifty-four faces, twenty-seven double sided cards would be used.

More generally, for the double sided card game implementation each side of each card has a color selected from at least two different colors, and at least one side of each card has at least one feature thereon. Preferably, three colors are used, for example red, blue, and yellow. Every card is different distinguished by its own color/feature combination. Both sides of a given card may be the same color. At least one side of each card may have two features one inlaid or inside the other, as described before with reference to FIGS. 13 and 14. The features may be selected from: a graphic, a letter and a number. The graphic may represent a shape and/or an object and/or a symbol. The shape may be a geometric shape, such as a circle, a square, a triangle, a diamond and kite. The object may be a vehicle, for example a car, a helicopter and a boat. The symbol may be a flag and/or an emblem.

Each side of a given card may have a different feature thereon. One side of the card may have at least one graphic and the one other side of the same card may have a letter or number thereon. At least some of the cards may have numbers. The numbers may part of a sequence or pattern of numbers. At least some of the cards may have letters and the letters may be part of a sequence or pattern of letters. Some cards may have a letter on one side and a number on the other side. The letters and numbers may be mapped, for example according to a sequence or pattern.

The colors may be primary colors. The colors may be red, yellow and blue. The cards may fit together to form a pre-determined shape. Some faces may be color only faces. For example, where there are three colors, there may be three color only faces for each color, such as three red only faces, three blue only faces and three yellow only faces. Each face that has a feature on it may be different from every other face that has a feature on it. The difference may be in the color of the face. For example, the same feature may be used multiple times, but on different colored faces.

The present invention brings the simple and complex challenges of life into an order, aligned with national curricula. It is the embodiment of communication, education, playing, learning, collaborating, smiling, laughing, trying, improving, memorizing, concentrating, exercising and at its core is the essence of a fundamental rite of passage. It is unique in exploring and developing the imagination and natural curiosity for learning that strives and exists in every child.

The puzzle may be of practical, beneficial use to sufferers of the Autism or Asperger's syndrome or dementia. As there are no language barriers, users of sign language (for example British sign language BSL) mainly deaf people are also able to take advantage of its practical and educational uses. Further use in the sporting field may be the testing of sports people/professionals' concentration and memory under fatigue and time/pressure conditions.

A skilled person will appreciate that variations of the disclosed arrangements are possible without departing from the invention. For example, any alphabet of any language could appear in part or full, within the puzzle Some languages have distinctly different symbols; examples being Hebrew, Cantonese, Egyptian, Arabic, Russian or any other symbol, number, letter or alphanumeric translation. Also, finer patterns with more detailed or complex faces could be used to increase difficulty/combinations. Accordingly, the above description of the specific embodiment is made by way of example only and not for the purposes of limitation. It will be clear to the skilled person that minor modifications may be made without significant changes to the operation described.

1. A puzzle comprising at least four blocks, each block having at least four sides, the at least four sides of each block having at least two different colors, at least one side of each block each having at least one feature thereon.

2. A puzzle as claimed in claim 1 wherein at least one side of each block has at least two features thereon.

3. A puzzle as claimed in claim 1, wherein at least one side of each block has at least two features thereon and one of the two features is inlaid or inside the other of the at least two features.

4. A puzzle as claimed in claim 1 wherein the features are selected from: a graphic, a letter and a number.

5. A puzzle as claimed in claim 4 wherein the feature is a graphic and the graphic represents a shape and/or an object and/or a symbol.

6. A puzzle as claimed in claim 5 wherein the feature is a graphic and the graphic represents a shape, wherein the shape is a geometric shape and is one of a circle, a square, a triangle, a diamond or kite.

7. A puzzle as claimed in claim 5 wherein the feature is a graphic that represents an object, wherein the object is a vehicle and is one of a car, a helicopter and or boat.

8. A puzzle as claimed in claim 5 wherein the feature is a graphic that represents a symbol, wherein the symbol is a flag and/or an emblem.

9. A puzzle as claimed in claim 1 wherein at least two sides of at least one block have different features thereon.

10. A puzzle as claimed in claim 1 wherein at least two sides of at least one block have different features thereon and at least one side of at least one block has at least one graphic and at least one other side of the same block has a letter or number thereon.

11. A puzzle as claimed in claim 1 wherein every block has a face that bears a number.

12. A puzzle as claimed in claim 1 wherein every block has a different number.

13. A puzzle as claimed in claim 1 wherein every block has a number that is part of a sequence or pattern of numbers.

14. A puzzle as claimed in claim 1 wherein every block has a letter.

15. A puzzle as claimed in claim 1 wherein every block has a different letter.

16. A puzzle as claimed in claim 1 wherein every block has a letter that is part of a sequence or pattern of letters.

17. (canceled)

18. A puzzle as claimed in claim 1 wherein the colors are red, yellow and blue.

19. A puzzle as claimed in claim 1 wherein each block is has six sides.

20. (canceled)

21. (canceled)

22. A puzzle as claimed in claim 1 comprising nine blocks.

23. (canceled)

24. A puzzle as claimed in claim 1 wherein every face of every block has a color and at least one feature thereon.

25. A puzzle as claimed in claim 1 wherein the at least one feature is represented in braille.

26. A puzzle as claimed in claim 1 comprising a plurality of flash cards each defining a different pattern that has to be recreated using the blocks.

27. (canceled)

28. (canceled)

29. A puzzle as claimed in claim 1 wherein the blocks are physical blocks.

30. A puzzle as claimed in claim 1 wherein each block is a physical block and has dimensions in a range of either 1 cm to 5 cm or 5 cm to 10 cm.

31. A puzzle as claimed in claim 29 wherein each block is a physical block and has at least one dimension greater than 20 cm.

32. A puzzle as claimed in claim 1 wherein the blocks are generated using computer graphics.

33. A puzzle comprising multiple double sided playing cards, each side of each card having a color selected from at least two different colors, and at least one side of each card has at least one feature thereon.

34. A puzzle as claimed in claim 33 wherein at least one side of each card has at least two features thereon.

35. A puzzle as claimed in claim 34, wherein one of the two features is inlaid or inside the other of the at least two features.

36. A puzzle as claimed in claim 33 wherein the features are selected from: a graphic, a letter and a number.

37. A puzzle as claimed in claim 36 wherein the feature is a graphic and the graphic represents a shape and/or an object and/or a symbol.

38. A puzzle as claimed in claim 37 wherein the feature is a shape and the shape is a geometric shape and is one of a circle, a square, a triangle, a diamond or kite.

39. A puzzle as claimed in claim 37 wherein the feature is an object and the object is a vehicle and is one of a car, a helicopter and or boat.

40. A puzzle as claimed in claim 37 wherein the feature is a symbol and the symbol is a flag and/or an emblem.

41. A puzzle as claimed in claim 33 wherein each side of a given card has a different feature thereon.

42. A puzzle as claimed in claim 33 wherein each side of a given card has a different feature thereon and one side of the card has at least one graphic and the one other side of the same card has a letter or number thereon.

43. A puzzle as claimed in claim 33 wherein at least some of the cards have numbers, thereon and the numbers are part of a sequence or pattern of numbers.

44. A puzzle as claimed in claim 33 wherein at least some of the cards have letters, thereon and the letters are part of a sequence or pattern of letters.

45. (canceled)

46. A puzzle as claimed in claim 33 wherein the colors are red, yellow and blue.

47. (canceled)

48. (canceled)

49. A puzzle as claimed in claim 33 wherein the at least one feature is represented in braille.

50. A puzzle as claimed in claim 33 comprising a plurality of flash cards each defining a different pattern that has to be recreated using the double sided cards.

51. (canceled)

52. (canceled)
